(19) United States
(12) Patent Application Publication
(10) Pub. No.: US 2021/0040982 A1
(43) Pub. Date: Feb. 11, 2021

(54) SELF-LOCKING SUCTION CUP

(71) Applicant: Xuanming DENG, Guangdong (CN)

(72) Inventor: Xuanming DENG, Guangdong (CN)

(21) Appl. No.: 16/533,797

(22) Filed: Aug. 7, 2019

(51) Int. Cl. F16B 47/00

(52) U.S. Cl. CPC F16B 47/00

(57) ABSTRACT

The utility model provides suction cup capable of self-locking, comprising movable assembly including suction cup body provided with suction cup surface and connecting mechanism connected to the suction cup surface, self-locking switch clamp—connected to the connecting mechanism, fixing cover sleeved outside the connecting mechanism, clamp seat clamp-connected to the self-locking switch, and elastic mechanism between the fixing cover and the clamp seat abutting the fixing cover and the clamp seat. Placing and pressing adsorbate on the suction cup surface creates vacuum cavity between the adsorbate and the suction cup surface, and vacuum suction force between the adsorbate and the suction cup surface is maintained by snap connection of the self-locking switch and the clamp seat. When re-pressing the adsorbate, the self-locking switch is disengaged from the clamp seat under resilience of the elastic mechanism, eliminating vacuum suction force between the adsorbate and the suction cup surface for removing the adsorbate.

### BACKGROUND OF THE INVENTION

The present utility model relates to a suction cup, in particular, to a suction cup capable of self-locking.

The existing suction cups on the market generally has to generate a vacuum suction force by manually locking the suction cup surface for sucking the object tightly or being adsorbed on the surface of the object. In the suction process of the suction cup, two hands are required, wherein on hand is used to press the suction cup to attach the suction cup tightly on the surface of the object, and the other hand is used to draw or press the handle of the suction cup to shape the suction cup surface to be a concave surface for generating a vacuum suction force between the suction cup and the surface of the object. When the suction state is released, also two hands are required to be in cooperation for releasing the suction. This suction process is complicated and requires two hands to complete the entire process.

### BRIEF SUMMARY OF THE INVENTION

The present utility model provides a self-locking suction cup, comprising a movable assembly.

the movable assembly includes a suction cup body provided with a suction cup surface and a connecting mechanism connected to the suction cup surface, a self-locking switch in clamp connection with the connecting mechanism, a fixing cover sleeved outside the connecting mechanism, a clamp seat in clamp connection with the self-locking switch, and an elastic mechanism disposed between the fixing cover and the clamp seat and abutting against the fixing cover and the clamp seat.

Preferably, the connecting mechanism has a hollow cylindrical structure;

the self-locking switch is provided with a snap portion in snap connection with the hollow cylinder, an extension extending to the inside of the hollow cylinder and provided with a buckle, and a self-locking portion in clamped connection with the clamp seat;

The end of the hollow cylinder is provided with a snap groove in snap-fit connection with the snap portion;

a side wall of the hollow cylinder is provided with a buckling groove matched with the buckle of the extension.

Preferably, the self-locking portion adopts an engagement member;

the clamp seat is provided with an engagement groove matched with the engagement member;

the engagement groove is used to be in matched engagement with the engagement member.

Preferably, the fixing cover is provided with a first abutting portion having a protruding surface used to abut against the elastic mechanism;

the clamp seat is provided with a second abutting portion that abuts against the elastic mechanism.

Preferably, a gasket is disposed between the second abutting portion of the clamp seat and the elastic mechanism;

the gasket is made of hard rubber material.

Preferably, the movable assembly further includes a decorative ring;

the decorative ring is sleeved outside the suction cup body.

Preferably, the suction cup surface is made of soft rubber material;

the elastic mechanism adopts a metal spring.

Preferably, it further comprises an outer casing covering the outer portion of the movable assembly, a fixing seat in a snap connection with the outer casing, and a nut in threaded connection with the fixing seat.

Preferably, the movable assembly is provided with a rotating assembly;

the rotating assembly is connected to the suction cup surface and is free to rotate.

Preferably, it further comprises a connecting seat sleeved around the suction cup body for causing the suction cup body to be in snap connection with the fixing cover.

As can be seen from the above technical solution, the present utility model has the following advantages:

in the present utility model, an adsorbate is placed on the suction cup surface and pressed such that a vacuum cavity is created between the adsorbate and the suction cup surface, and the suction cup surface is locked by the self-locking switch through the snap connection of the self-locking switch and the clamp seat; after the pressing force is released, the circumference of the movable assembly bounces back under the elastic force of the elastic mechanism, so that the suction cup surface is shaped into a concave surface to generate a vacuum suction force, and the vacuum suction force between the adsorbate and the suction cup surface is maintained. When the adsorbate is pressed again, the self-locking switch is disengaged from the clamp seat, and then under the resilience of the elastic mechanism and as the suction cup surface recovers to the current concave surface, the vacuum suction force between the adsorbate and the suction cup surface is lost, so the adsorbate may be removed.

In the present utility model, the design of self-locking is adopted, so that the locking and snapping are performed by pressing the self-locking switch of the suction cup surface, and the suction cup surface is shaped into a concave surface to generate a vacuum suction force for being sucked tightly on a flat object. All of the above operations may be performed by a single hand of a user, thereby facilitating convenience and practicality.

### BRIEF DESCRIPTION OF THE DRAWINGS

In order to be more clearly illustrating the technical solutions of the present utility model, the drawings which are required to be used in the description will be briefly described below. It is obvious that the drawings described below are only some embodiments of the present utility model. It will be apparent to one of ordinary skill in the art that other drawings may be obtained based on the accompanying drawings without inventive effort.

FIG. 1 is an overall structural view of an embodiment of the self-locking suction cup provided by the present utility model;

FIG. 2 is an overall structural view of an embodiment of the self-locking suction cup provided by the present utility model;

FIG. 3 is an exploded view of a movable assembly of an embodiment of the self-locking suction cup provided by the present utility model;

FIG. 4 is a structural view of a movable assembly and an outer casing of an embodiment of the self-locking suction cup provided by the present utility model;

FIG. 5 is an overall structural exploded view of an embodiment of the self-locking suction cup provided by the present utility model;

FIG. 6 is a static cross-section view of an embodiment of the self-locking suction cup provided by the present utility model;

FIG. 7 is a working cross-section view of an embodiment of the self-locking suction cup provided by the present utility model.

### REFERENCE NUMERALS

1 suction cup body, 2 self-locking switch, 3 connecting seat, 4 decorative ring, 5 fixing cover, 6 elastic mechanism, 7 gasket, 8 clamp seat, 10 movable assembly, 11 fixing seat, 12 nut, 21 suction cup surface, 22 connecting mechanism, 23 extension, 24 snap portion, 25 self-locking portion, 26 engagement groove, 27 first abutting portion, 28 second abutting portion, 29 outer casing, 31 snap groove, 32 buckle groove, 33 rotating assembly

### DETAILED DESCRIPTION OF THE INVENTION

To make the objects, features and advantages of the present utility model more obvious and easy to understand, the technical schemes of the embodiments of the present utility model are clearly and completely described below with reference to the accompanying drawings in the embodiments of the present utility model, it is apparent that the described embodiments are only a part of embodiments of the present utility model, instead of all the embodiments. Based on the embodiments of the present patent, all the other embodiments obtained by that of ordinary skill in the art without inventive effort are within the scope of the present patent.

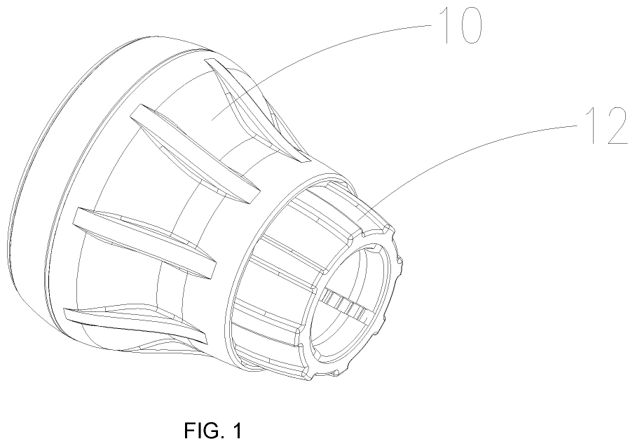

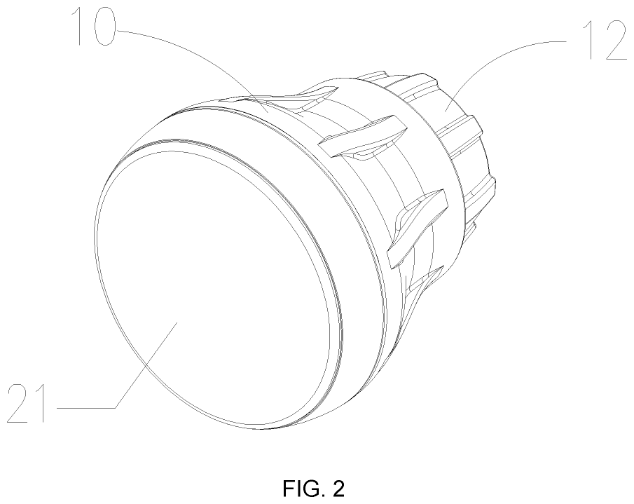

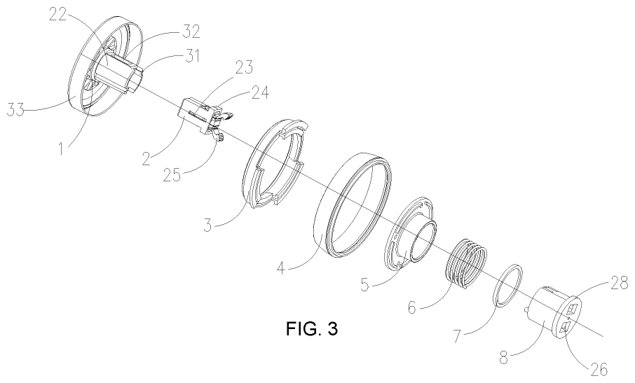

The present embodiment provides a self-locking suction cup, with reference to FIGS. 1 and 2 in a combination of FIG. 3. It includes: a movable assembly 10;

the movable assembly 10 includes a suction cup body 1 provided with a suction cup surface 21 and a connecting mechanism 22 connected to the suction cup surface 21, a self-locking switch 2 in clamp connection with the connecting mechanism 22, a connecting seat 3 sleeved around the suction cup body 1 for causing the suction cup body 1 to be in snap connection with the movable assembly 10, a decorative ring 4 sleeved around the suction cup body 1 for causing the suction cup body 1 to be in snap connection with the movable assembly 10, a fixing cover 5 sleeved outside the connecting mechanism 22, a clamp seat 8 in clamp connection with the self-locking switch 2, an elastic mechanism 6 disposed between the fixing cover 5 and the clamp seat 8 and abutting against the fixing cover 5 and the clamp seat 8, and a gasket 7 disposed between the elastic mechanism 6 and the fixing cover 5.

As can be seen, an adsorbate is placed on the suction cup surface 21, and pressed such that the movable assembly 10 is pressed together with the adsorbate, the suction cup surface 21 is tightly attached to the adsorbate; when the adsorbate is released, a part of the suction cup surface 21 is tightly attached to the adsorbate, but the part of the suction cup surface 21 connected to the connecting mechanism 22 may not recover to the state before pressing due to the clamping between the self-locking switch 2 and the clamp seat 8; through the clamping between the self-locking switch 2 and the clamp seat 8, the center of the suction cup 21 is fixed, and the movable assembly 10 is placed under the elastic force of the elastic mechanism, so that the suction cup surface 21 is shaped into a concave surface to create a vacuum cavity, which maintains a vacuum suction force between the adsorbate and the suction cup surface 21. When the adsorbate is pressed again, the self-locking switch 2 is disengaged from the clamp seat 8, and then under the resilience of the elastic mechanism 6, the suction cup surface 21 recovers to the current concave surface, the vacuum suction force between the adsorbate and the suction cup surface is lost, so the adsorbate may be removed. With the design of self-locking, the locking and snapping is performed by pressing the self-locking switch 2 of the suction cup surface, and the periphery of the movable assembly is topped by the elastic mechanism 6, so that a vacuum suction force is generated between the adsorbate and the suction cup surface 21 for being sucked tightly on a flat object. All of the above operations may be performed by a single hand of a user, thereby facilitating convenience and practicality.

In the present embodiment, the self-locking suction cup may be directly sucked to a flat product. For example, mobile phones, tablets, navigators, MP3/MP4, etc., including daily household tableware, sanitary ware, etc.

In the present embodiment, the connecting mechanism 22 has a hollow cylindrical structure;

the self-locking switch 2 is provided with a snap portion 24 in snap connection with the hollow cylinder, an extension 23 extending to the inside of the hollow cylinder and provided with a buckle, and a self-locking portion 25 in clamped connection with the clamp seat 8; an end of the hollow cylinder is provided with an snap groove 31 in snap-fit connection with the snap portion 24; a side wall of the hollow cylinder is provided with a buckle groove 32 matched with the buckle of the extension 23.

It can be appreciated that the extension 23 of the self-locking switch 2 is inserted into the interior of the hollow cylinder, and the extension 23 is matched with the internal shape of the hollow cylinder. For example, the extension portion 23 has a quadrangular structure, and the inside of the hollow cylinder is matched with the quadrilateral structure of the extension 23, so that the self-locking switch 2 may be prevented from rotating relative to the connecting mechanism 22. As such, the position of the self-locking portion 25 is always corresponding to the position of the buckle groove 26 of the clamp seat 8. Similarly, the matched connection of the snap portion 24 and the snap groove 31 also prevents the self-locking switch 2 from rotating relative to the connecting mechanism 22, thereby ensuring that the position of the self-locking portion 25 is always corresponding to the position of the snap groove 26 of the clamp seat 8. The locking engagement between the buckle of the extension 23 and the locking groove 32 of the side wall of the hollow cylinder may prevent the self-locking switch 2 from sliding out of the hollow cylinder of the connecting mechanism 22, may ensure that the self-locking switch 2 is inserted into the connecting mechanism 22 and may not move relative to each other, may ensure the position of the self-locking portion 25 is always corresponding to the position of the snap groove 26 of the clamp seat 8. However, the clamp seat 8 is loosely fixed in the fixing seat 11 by screws, and due to the loose fixing, the movable assembly may be freely rotated upon rotating when the self-locking switch 2 is snapped into the clamp seat 8.

In the present embodiment, the self-locking portion 25 adopts an engagement member; the clamp seat 8 is provided with an engagement groove 26 matched with the engagement member; the engagement groove 26 is used to be in matched engagement with the engagement member, so that a vacuum cavity is formed between the adsorbate and the suction cup surface 21 to maintain a vacuum suction force between the adsorbate and the suction cup surface 21.

In the present embodiment, the fixing cover 5 is mounted on the fixing seat 11, and the fixing cover 5 is provided with a first abutting portion 27 having a protruding surface used to abut against the elastic mechanism 6; the clamp seat 8 is provided with a second abutting portion 28 that abuts against the elastic mechanism 6. A gasket 7 is disposed between the second abutting portion 28 of the clamp seat 8 and the elastic mechanism 6; the gasket 7 is made of hard rubber material.

It can be appreciated that both ends of the elastic mechanism 6 are respectively abutted against the first abutting portion 27 and the second abutting portion 28. When the adsorbate is pressed, the elastic mechanism 6 is compressed, but when the pressed adsorbate is released, the state before the pressing may not be restored due to the engagement between the self-locking switch 2 and the clamp seat 8. The movable assembly 10 is bounced back under the rebound of the elastic mechanism 6, so that the suction cup 21 is shaped into a concave surface to generate a vacuum suction force, allowing the adsorbate may be sucked. When the adsorbate is pressed again, the self-locking switch 2 is disengaged from the clamp seat 8 under the resilience of the elastic mechanism 6, and the entire surface of the suction cup surface 21 is tightly attached to the adsorbate, so that the vacuum suction force between the adsorbate and the suction cup surface is lost and the adsorbate may be removed.

In the present embodiment, the elastic mechanism 6 is made of a metal spring or a resilient elastic material, such as high-density soft rubber, sponge, etc.

In the present embodiment, the suction cup surface 21 is made of soft rubber material.

In the present embodiment, the movable assembly 10 further includes a decorative ring 4; the decorative ring 4 is sleeved on the outside of the suction cup body 1 to serve as a decorative appearance. The decorative ring 4 is made of plastic material

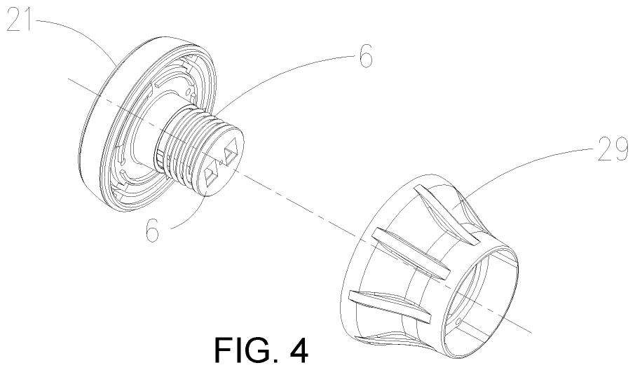

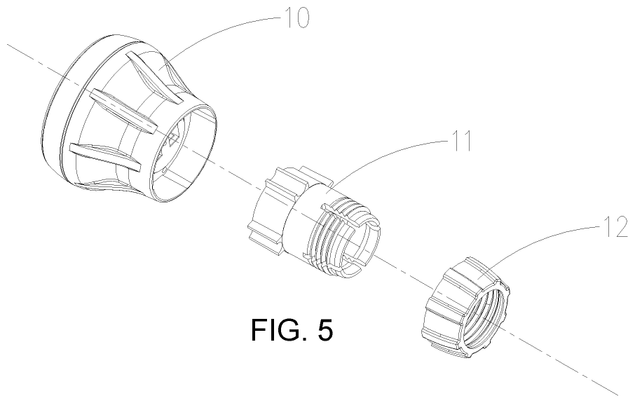

In the present embodiment, with reference to FIGS. 4 and 5, it further comprises an outer casing 29 covering the outer portion of the movable assembly 10, a fixing seat 11 in snap connection with the outer casing 29, and a nut 12 in threaded connection with the fixing seat 11. The fixing seat 11 is used to mount and fix the self-locking suction cup on the external fixing bracket or the bracket such that the user may use it in any occasion, and then is tightened with the nut 12 and fixed to an external fixing bracket or bracket. The nut 12 may be made of plastic material.

In the present embodiment, it further comprises a connecting seat 3 sleeved around the suction cup body 1 for causing the suction cup body 1 to be in snap connection with the fixing cover 5.

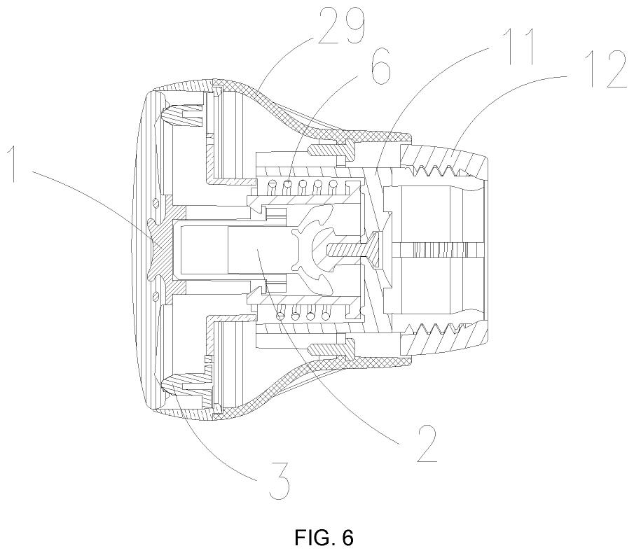

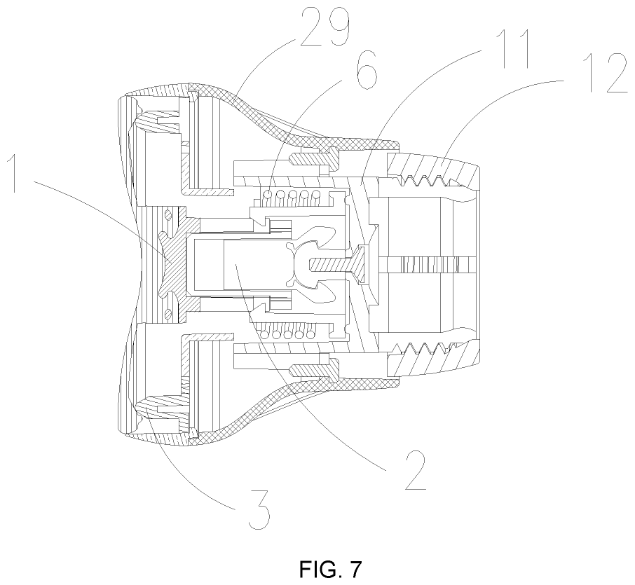

In order to more fully describe the operation mode of the present utility model, the following uses a mobile phone as an example, with reference to FIGS. 6 and 7:

A user holds the mobile phone on the suction cup surface 21 while gently pressing it down, so that the movable assembly 10 moves in the direction of the fixing seat 11, and the self-locking switch 2 locks and clamps the snap groove 26, at which time the center of the soft plastic suction cup surface 21 is locked such that the movable assembly 10 is bounced back under the resilience of the elastic mechanism 6, and the soft plastic suction cup surface is recessed to create a vacuum cavity to generate a vacuum suction force between the mobile phone and the suction cup surface 21, then the mobile phone is sucked tightly on the suction cup surface 21 and is in a state of suction. When the user has to remove the mobile phone, the hand holds the mobile phone and gently presses down the suction cup surface 21, and the self-locking switch is released, so that the movable assembly 10 is reset by the elastic force of the elastic mechanism 6, at which time the vacuum suction between the mobile phone and the suction cup surface 21 is lost, then the mobile phone may be removed.

The movable assembly 10 is further provided with a rotating assembly, and the rotating assembly is fixedly mounted with the suction cup surface 21; the snapped connection is performed on the fixing cover 5, so it may be rotated 360° freely, which is suitable for users to perform at different angles.

Each embodiment in the specification is described in a progressive manner, the emphasis of each embodiment is put on explaining the difference from other embodiments and the same or similar parts of each embodiment may refer to each other.

The above description of the disclosed embodiments enables those skilled in the art to make or use the present utility model. Various modifications on the embodiments are evident to those in the art, and the principle defined in the present utility model can be realized in other embodiments without departing from the scope or spirit of the present utility model. Therefore, the present utility model is not limited to the disclosed embodiments, but conforms to the widest scope that is consistent with the principle and novel characteristics of the present utility model.

What is claimed is:

1. A self-locking suction cup, characterized by comprising a movable assembly;
the movable assembly includes a suction cup body provided with a suction cup surface and a connecting mechanism connected to the suction cup surface, a self-locking switch in clamp connection with the connecting mechanism, a fixing cover sleeved outside the connecting mechanism, a clamp seat in clamp connection with the self-locking switch, and an elastic mechanism disposed between the fixing cover and the clamp seat and abutting against the fixing cover and the clamp seat.

2. The self-locking suction cup according to claim 1, characterized in that,
the connecting mechanism has a hollow cylindrical structure;
the self-locking switch is provided with a snap portion in snap connection with the hollow cylinder, an extension extending to the inside of the hollow cylinder and provided with a buckle, and a self-locking portion in clamped connection with the clamp seat;
an end of the hollow cylinder is provided with a snap groove in snap-fit connection with the snap portion;
a side wall of the hollow cylinder is provided with a buckling groove matched with the buckle of the extension.

3. The self-locking suction cup according to claim 2, characterized in that,
the self-locking portion adopts an engagement member;
the clamp seat is provided with an engagement groove matched with the engagement member;
the engagement groove is used to be in matched engagement with the engagement member.

4. The self-locking suction cup according to claim 1, characterized in that,
the fixing cover is provided with a first abutting portion having a protruding surface used to abut against the elastic mechanism;
the clamp seat is provided with a second abutting portion that abuts against the elastic mechanism.

5. The self-locking suction cup according to claim 4, characterized in that,
a gasket is disposed between the second abutting portion of the clamp seat and the elastic mechanism;
the gasket is made of hard rubber material.

6. The self-locking suction cup according to claim 1, characterized in that,
the movable assembly further includes a decorative ring;
the decorative ring is sleeved outside the suction cup body.

7. The self-locking suction cup according to claim 1, characterized in that,
the suction cup surface is made of soft rubber material;
the elastic mechanism adopts a metal spring.

8. The self-locking suction cup according to claim 1, characterized in that,
an outer casing covering the outer portion of the movable assembly, a fixing seat in snap connection with the outer casing, and a nut in threaded connection with the fixing seat.

9. The self-locking suction cup according to claim 1, characterized in that,
the movable assembly is provided with a rotating assembly;
the rotating assembly is connected to the suction cup surface and is free to rotate.

10. The self-locking suction cup according to claim 1, characterized in that,
a connecting seat sleeved around the suction cup body for causing the suction cup body to be in snap connection with the fixing cover.
